(19) United States
(12) Patent Application Publication
(10) Pub. No.: US 2006/0259959 A1
(43) Pub. Date: Nov. 16, 2006

(54) Method and apparatus for indicating computer system access

(75) Inventors: John T. Earl, Gig Harbor, WA (US); Ronald Gary Monier, Kirkland, WA (US); Donald A. Whittaker, Seattle, WA (US)

Correspondence Address: PowerTech Group Inc, 19426 68th Ave. South, Kent, WA, 98032, US

(73) Assignee: PowerTech Group Inc

(21) Appl. No.: 11/200,807

(22) Filed: Aug. 10, 2005

Related U.S. Application Data
(63) Continuation-in-part of application No. 11/129,825, filed on May 16, 2005.

(51) Int. Cl. H04L 9/32

(52) U.S. Cl. 726/6

(57) ABSTRACT

A method and apparatus for indicating access to information in a computer system. A profile is provided to one or more system users. The profile indicates predetermined access privileges to the information in the computer system. A user may attempt accessed the computer system and change its profile to another profile. Upon this attempt to change the profile an indication may be logged into the system and be automatically provided to a third party.

### RELATED APPLICATIONS

This application is a continuation-in-part of U.S. patent application Ser. No. 11/129,825, filed May 16, 2005.

### FIELD OF THE INVENTION

The invention relates to the field of indicating access to information stored in a computer system.

### BACKGROUND

A method and apparatus for indicating access to information stored in a computer system is disclosed.

Accessing computers to repair or update information (for example, files, records, programs or database content), such as those computers used by financial institutions, typically involves an authorized computer user or administrator logging into the computer system under a specific predefined profile. When the computer system is initially set-up, the specific profile is pre-assigned to the user. The profile defines the access rights to the information in the computer system. Such rights to information in one profile could include additional or lesser information than in another profile. Once the user logs in to the computer system under a profile, the user can then access all information authorized for that profile including the information necessary for the user to perform a repair or upgrade.

One of the drawbacks of enabling the user access pursuant to the predefined profile is that the administrator may be able to access additional information in the computer system. Such access to additional information may be unnecessary to perform a repair or upgrade. Thus the administrator may obtain unauthorized access to additional highly sensitive information. Further the administrator may be able to unknowingly modify the files, programs or content thereby creating a system security breach. When the administrator obtains access to the information, management may not become aware of the access to the system or may not be able to become aware of the access to the system until after a breach. Finally once the breach has occurred or is attempting to occur, there may not be a mechanism to track the attempt or take corrective action.

### SUMMARY OF THE INVENTION

A method and apparatus for indicating access to information in a computer system is disclosed. A profile is provided to one or more system users. The profile indicates predetermined access privileges to the information in the computer system. One of the system users may access the information in the computer system in accordance with the first profile. The system user may attempt to change (i.e. swap) its profile to another profile. Upon this attempt, an indication may be provided to a second user, such as a manager or an executive that may approve or disapprove of the swap.

### DESCRIPTION OF THE FIGURES

FIG. 1 is a flow diagram showing interaction between users of a computer system in accordance with the invention.

FIG. 2 is a flow diagram of the program executing on the computer system in accordance with the invention.

FIG. 3a-3n are screen shots of the method for indicating access to information in the computer system in accordance with the invention.

FIG. 4 is a simplified block diagram of a computer system for managing access to information in accordance with the invention.

### DESCRIPTION OF THE PREFERRED EMBODIMENTS

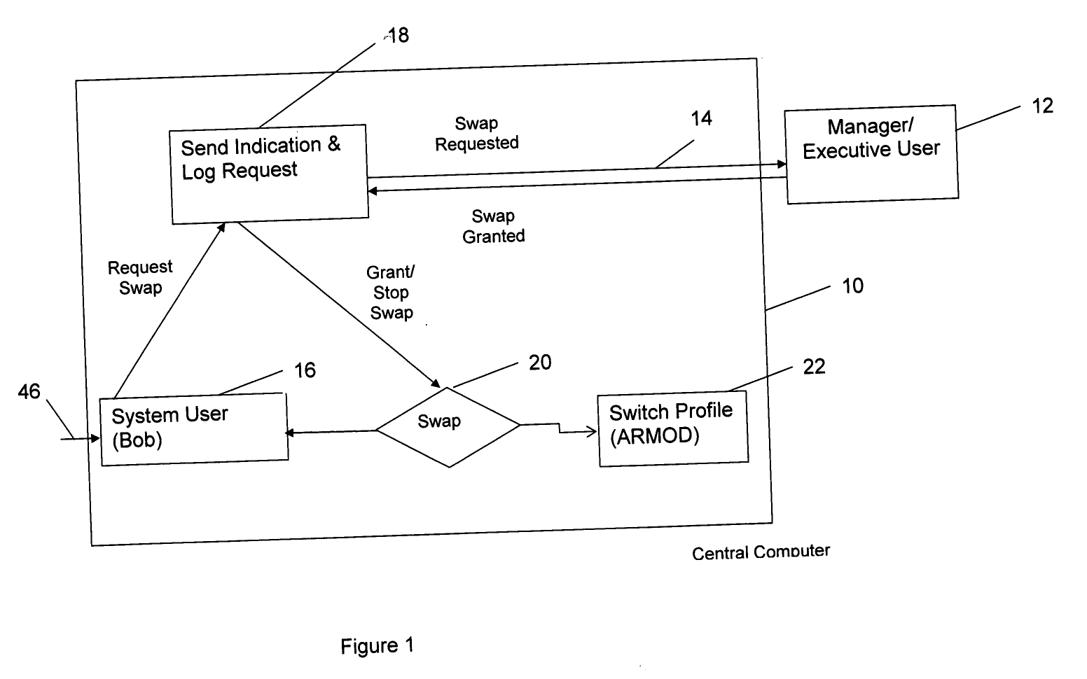

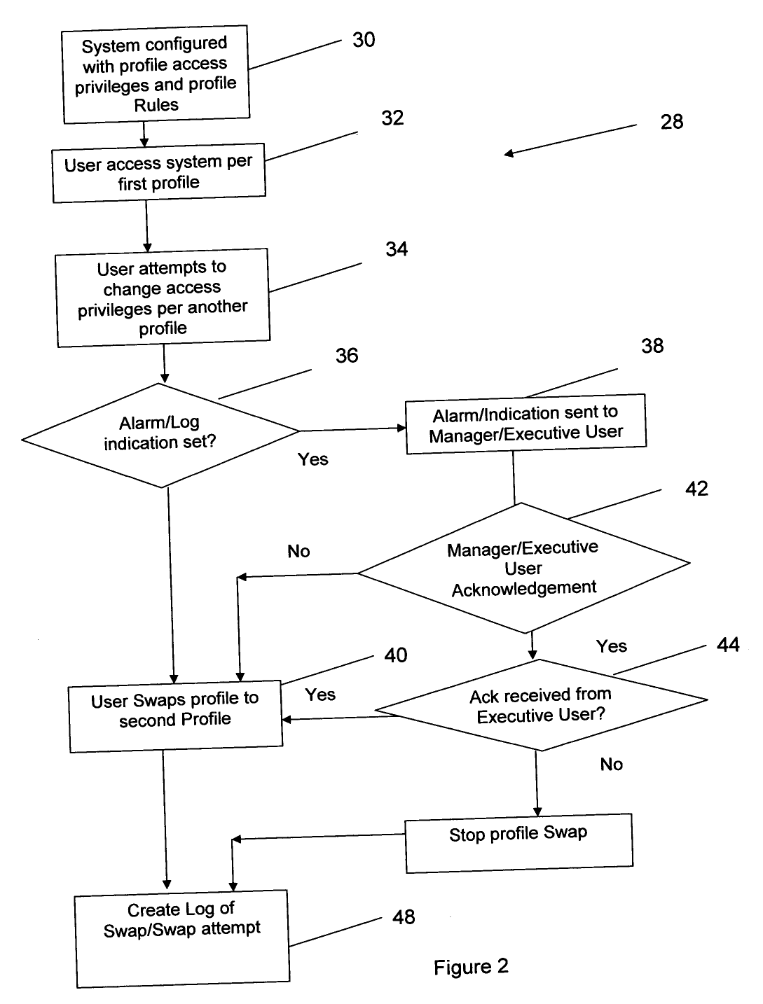

Referring to FIG. 1, there is shown a flow diagram detailing the interaction between users of central computer 10 (or multiplicity of computers) that executes a software application 28 (FIG. 2) that indicates access to information in accordance with the claimed embodiment. The central computer 10 transmits such information to a manager/executive user computer 12 via communications network 14. The software application 28 may be executed on any computer operating system, examples of which include, but are not limited to, Linux, Unix, Windows, as well as OS/400, i5/OS and associated iSeries, and AS400 computer systems that run such an operating system. The iSeries and AS400 computer systems and associated operating systems are available from IBM of Schenectady, N.Y.

When operating computer 10, a system user may, using input device 15, request access to a specific profile or attempt to change its profile. Details of a method for a user to access and change its profile are described in co-pending U.S. patent application Ser. No. 11/129,825, filed May 16, 2005 which is hereby incorporated by reference. The profiles available for a system user and access rights associated with each of the profiles may preferably be pre-configured outside of the application, for example as part of the operating system set up, or upon initial installation of the application.

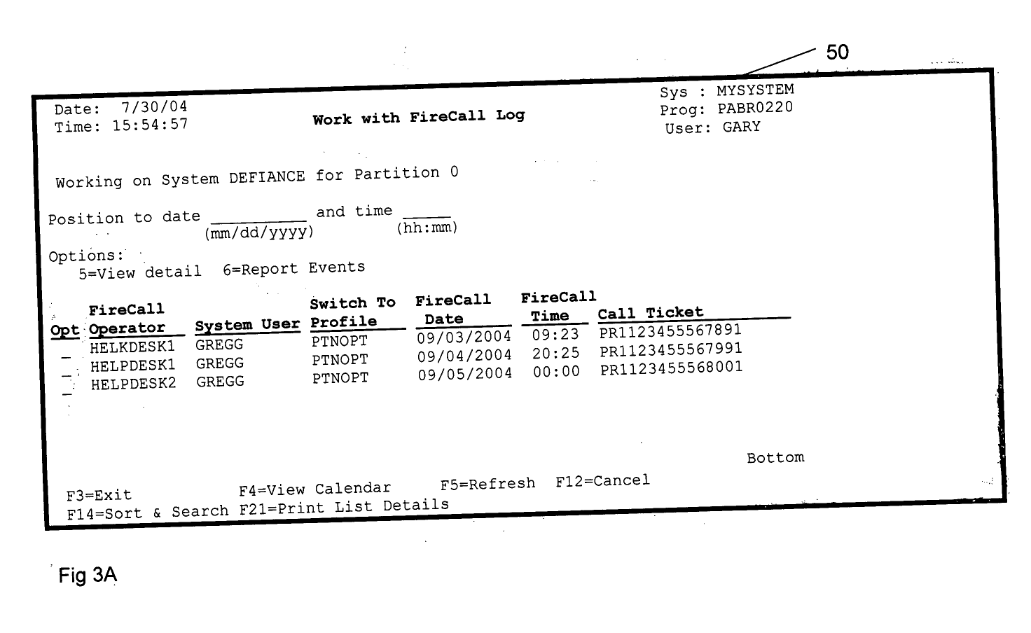

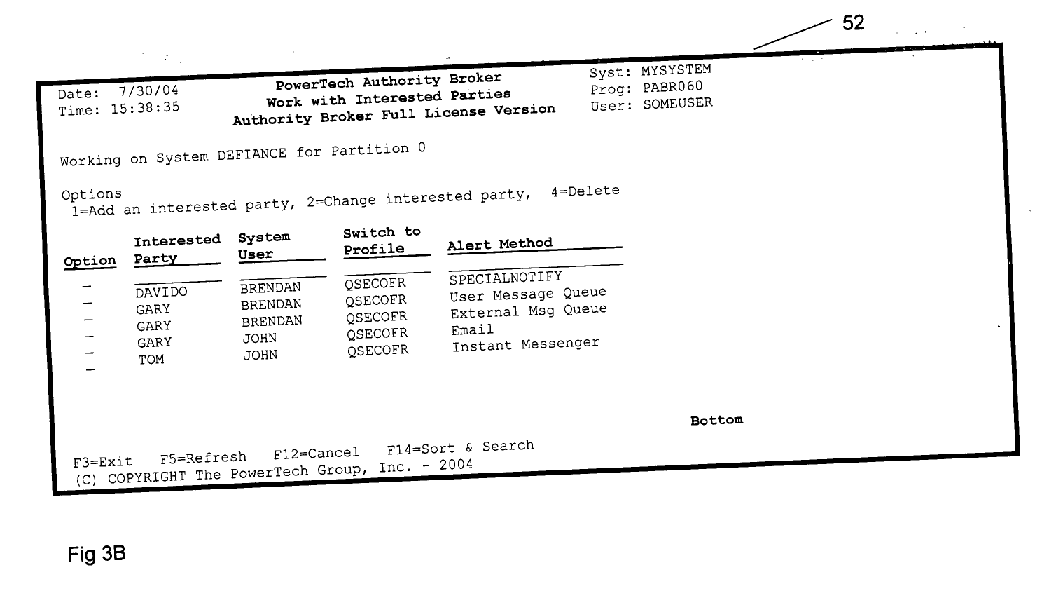

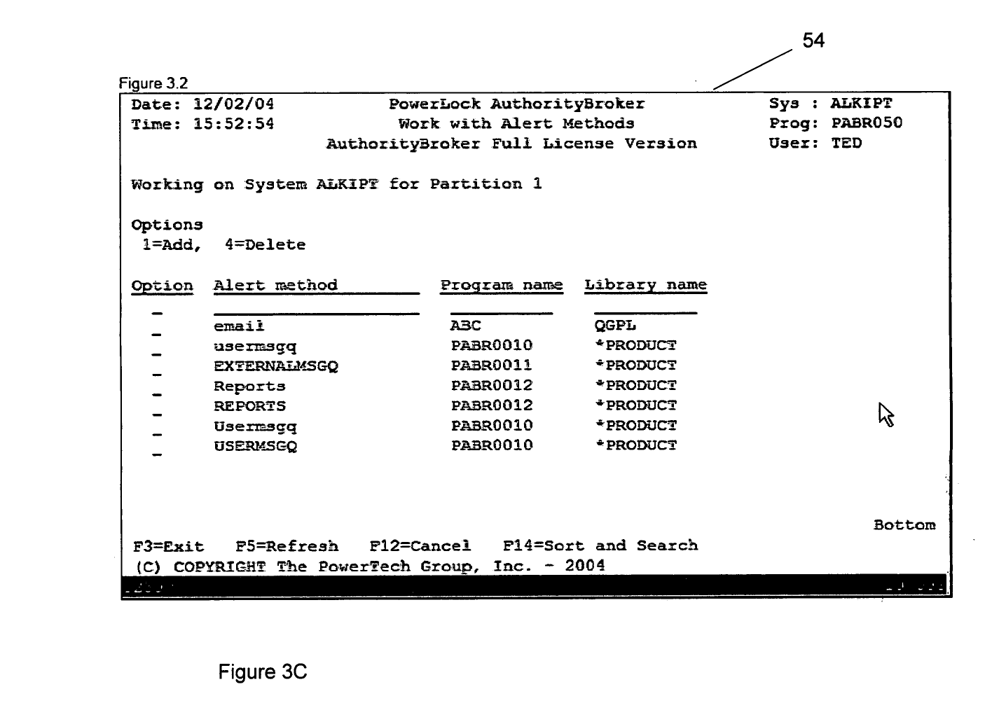

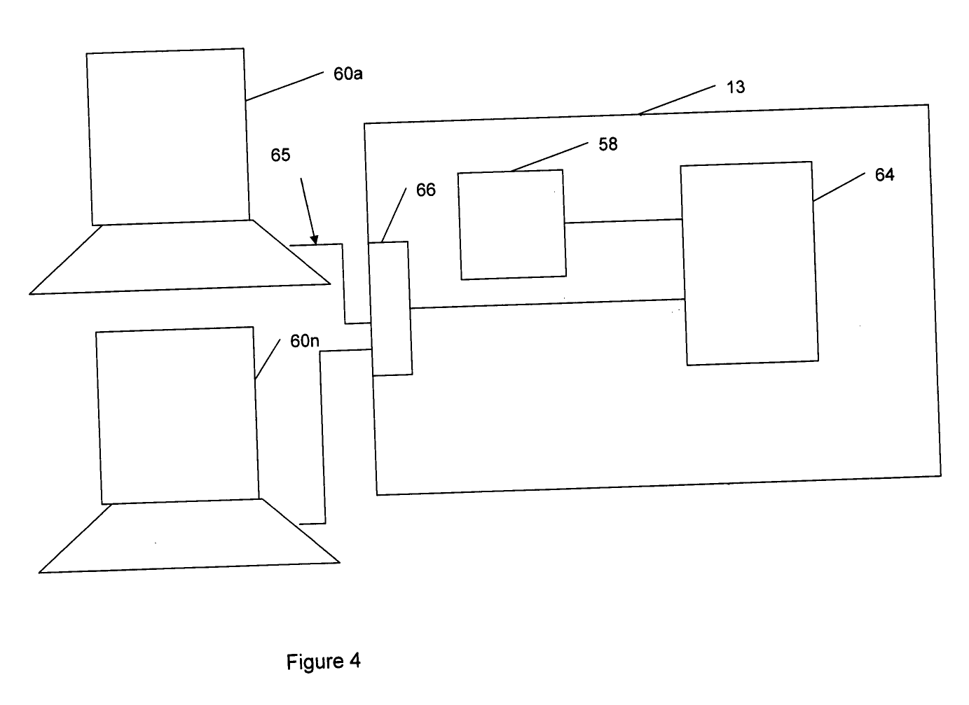

These profiles and rights associated with these profiles are stored in a database within a memory 58 (FIG. 4) of central computer 10. Memory 58 may be any type of information storage device, including but not limited to disk storage, hard drive, optical storage medium, Random Access Memory or silicon based memory. An exemplary graphical display showing a screen shot used in setting up these profiles is shown in FIG. 3A-3B.

A system user may typically log into the system under a first profile in block 16. One example of such a profile shown is Bob's profile. The system user logged in under the Bob profile in block 16 may then need to change it rights to the rights of another profile to obtain new access privileges under another profile, e.g. ARMOD profile.

Upon requesting access to or attempting to access the ARMOD profile, block 16 may send an indication to module 18, where a log of the request to change the system user's profile may be stored. In addition an indication of the profile swap request may be automatically sent as an alarm to manager/executive user computer 12 via network 14 using conventional transmission means. Methods for indicating the swap request are described in more detail in connection with FIG. 2. The manager/executive user computer 12, which may be located remotely from computer 10, may receive an informational alarm or alert indicating the swap request, or may send an approval or denial of the request back to module 18 via network 14. Module 18 may then send an indication of the approval or denial of the request to swap block 20. Upon the receipt of approval of the request from block 18, the system user may be permitted to change its profile to the rights of the exemplary ARMOD profile in block 22. Details of the software application, executed by computer 10 to carry out the aforementioned method described in FIG. 1, is shown in more detail in FIG. 2.

Referring to FIG. 2, there is shown a flow chart of an application 28 that may be executed on the operating system (e.g. OS/400) that when run results in the log/alarm indication described in FIG. 1. In step 30 the computer 10 is configured with profile access privileges as well as profile rules as previously described. Alternative, the rules and privileges may be configured by a help desk operator. Also set are the parameters around the switch activity and the internal notifications for when the switch occurs. For example alarms could be automatically sent to various system users, including but not limited to a manager/executive user 12 upon a switch, and upon a switch an automatic log entry of the switch could be stored in the systems memory 58. Further the system could be configured to require an acknowledgement from a manager/executive user 12 before a profile swap could be enabled.

In step 32, the system user using the input device 15 accesses the system 10 in accordance with the first profile. In step 34, also using input device 15, the user may attempt to change its access privileges to another profile. Upon the attempt to change its privileges, the system 10 determines if an alarm/log indication is required to be set in step 36. If the alarm/log indication is to be set, an alarm indication is sent to one or more manger/executive users (transmitted to other third party users as herein described) in step 38. In step 42 the manger/executive computer 12 (or more similar computers) may provide an acknowledgement back to the computer 10.

If the alarm/log indication is not required to be set, or if one of the the Manger/executive user's computer 12 is not configured to provide an acknowledgement, the user in step 40 may swap its profile to another second profile (e.g. ARMOD as described in FIG. 1).

If the Manager/Executive user computer 12 is required to provide an acknowledgement before a swap to another profile by the system user can occur, in step 44 the computer 10 determines if an acknowledgement has been received from the manger/executive user computer 12. If it has been received, then the user may swap the profile as previously described in step 40. If no acknowledgement has been received or if a denial of the profile acknowledgement is received, then computer 10 in step 46 may prevent the user from changing its profile. Although in step 46, the user is prevented form changing its profile in response to a denial requires, the user may be preconfigured to be prevented from changing its profile to specific profiles, regardless of success or failure of the approval process, A log of the swap/swap attempt may then be created in step 48. In addition after the swap profile in step 40 occurs, a log may be created in step 48 as well indicating that a swap has occurred.

Once the profile change has been activated, the system user could then access information or records in the system 10 in accordance with the rights provided under the switched profile (e.g. ARMOD).

Referring to FIG. 3A, there is shown an exemplary display screen of the initial setup of the swap table 50 which is stored in memory 58. The table may be completed by a product administrator and may specify the system user that is allowed to switch, the application profile the user may switch to and the circumstances of the switch (e.g. a firecall). Other parameters that may be entered into table 50 are the time that the switch may be activated and individuals that are to be notified when the switch is activated.

Referring to FIG. 3B, there is shown an exemplary display screen 52 that may be accessed in step 30. Such screen may be filled in by a system administrator and stored in system memory 58 to set the alert method and/or person to be notified in the event of an attempt to change the switch profile in step 34. The system administrator may enter, change or delete the interested party. The system administrator may set who may be alerted, or may set the alert method, examples of which include, but are not limited to a user message queue, an external message queue, an e-mail, an instant messenger, or a special notification message. The system administrator may also set on or more of the third parties/execute users will be alerted depending on which profile a system user attempt to access.

Referring to FIG. 3C, there is an exemplary screen 54 showing the alert method that may be added or deleted by a system administrator. These alert methods include but are not limited to e-mail, user messages, external messages, or automatic generation of reports. These alert methods may be initiated by application 28 calling, in step 38, an external program located in a prestored library that is tasked to complete a preprogrammed alert method.

Referring to FIG. 4, there is shown an exemplary computer 10, e.g. computing device 13, coupled to terminals 60a-n that may execute code of the application described in FIGS. 1 and 2. Computing device 13, are generally known to one skilled in the art and may include a processor 64 (or multiple processors) coupled to memory 58, examples of which may include but is not limited to, a storage media such as a RAM, optical drive, magnetic disk drive. The computer, application 28 described in FIG. 1 and FIG. 2 may be stored in memory 58. Processor 64 may be coupled to computer terminals 60a-60n through network interface 66. Processor 64 is generally known and may include a microprocessor or a central processing unit (CPU). Processor 64 executes the instruction stored in memory 58 and accesses data, information or records stored in memory 58. Although data is described stored in a memory 58 of computing device 13, data may be stored at remote locations on network 65. Terminals 60a-60n may be a dedicated standalone device or be a terminal emulator running on a pc, laptop, handheld device, mobile device or any other computing device. Terminals 60a-60n may be disposed locally or at remote locations and be connected though network 65 via an internet or an intranet communications network.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method for indicating access to information in a computer system comprising:
providing a first and second profile access to one or more system users, the first profile indicating predetermined access privileges to the information in the computer system, the second profile indicating access privileges to additional, or lesser information in the computer system;
accessing the first profile by one of the system users;
attempting by a system user, to change its profile from the first profile to the second profile; and
providing an indication to a one or more third parties upon an attempt to change the system users profile from the first profile to the second profile.

2. The method as recited in claim 1 further comprising providing a log of activity by the system user after temporarily swapping the first profile with the second profile.

3. The method as recited in claim 1 wherein information in the second profile is not accessible in the first profile.

4. The method as recited in claim 1 wherein information in the first profile is not accessible in the second profile.

5. The method as recited in claim 1 further comprising attempting by a second system user to change its profile from a third profile to the second profile; providing an indication to the second user when the second system user changes its users profile to the second profile.

6. The method as recited in claim 5 further comprising setting by a system administrator a first change of profile condition in which the indication is provided to a first party and a second change of profile condition in which the indication is provided to a second party.

7. The method as recited in claim 1 wherein the indication is provided via a group selected from: a text message, an e-mail message, a page message, a report buffer and updating of a file system.

8. The method as recited in claim 1 further comprising including in the generating a report an indication of what was done after the profile swap or, whether or not the attempt to swap the profile was allowed.

9. A computer system for indicating access to information comprising:
memory comprising a database of information having records;
display operative to indicate a first profile that corresponds to predetermined access privileges by a system user to portions of the records in the memory and to indicate a second profile that corresponds to predetermined access privileges by the system user to other portions of the records in the memory;
input device operative to generate a signal indicating an attempt change the profile of the system user from the first profile to the second profile; and
processing circuit for enabling access to the memory in accordance with the first profile, said processing circuit indicating, in response to the signal from the input device selecting the second profile, an attempt by a system user to change its profile from the first profile to the second profile, and for providing an indication to an output device upon an attempt to change the system users' profile from the first profile to the second profile.

10. The computer system as recited in claim 9, wherein the processing circuit is adapted to provide a log of activity by a system in response to an attempt to change the first profile to the second profile.

11. The computer system as recited in claim 9 wherein information in the second profile is not accessible in the first profile.

12. The computer system as recited in claim 9 wherein the input device is operative to provide a signal indicating an attempt by a second system user to change its profile from a third profile to the second profile; and wherein said processing circuit is operative to provide an indication to the second user when the second system user attempts to change its user profile to the second profile.

13. The computer system as recited in claim 9 wherein the processing circuit is operative to set by a system user the change of profile condition on when the indication is provided to the system user or a third party user.

14. The computer system as recited in claim 9 wherein the processing circuit is operative to provide an indication via a group selected from: a text message, and e-mail message, a page message, and report buffer and updating of a file system.

15. The computer system as recited in claim 9 wherein the processing circuit is operative to generating a report indicating of what was done after the profile swap, whether or not the attempt to swap the profile was authorized.

16. A computer readable medium having instructions which when executed by a processing device comprise:
providing a first and second profile access to one or more system users, the first profile indicating predetermined access privileges to the information in the computer system, the second profile indicating access privileges to additional information in the computer system;
accessing the first profile by one of the system users;
attempting by a system user, to change its profile from the first profile to the second profile; and
providing an indication to a second user upon an attempt to change the system users profile from the first profile to the second profile.

17. The computer readable media as recited in claim 16 further comprising instructions for providing a log of activity by the system user after temporarily swapping the first profile with the second profile.

18. The computer readable media as recited in claim 16 wherein information in the second profile is not accessible in the first profile, or wherein information in the first profile is not accessible in the second profile.

19. The computer readable media as recited in claim 16 further comprising instructions when executed by a processor attempt by a second system user to change its profile from a third profile to the second profile; and provide an indication the second user when the second system user changes its users profile to the second profile.

20. The computer readable media as recited in claim 19 further comprising instruction when executed by a processor set by a system user the change of profile condition on when the indication is provided to the system user or a third party user.

21. The computer readable media as recited in claim 17 wherein the indication is provided via a group selected from: a text message, and e-mail message, a page message, and report buffer and updating of a file system.

22. The computer readable media as recited in claim 16 further comprising instructions when executed by a processor include in the generating a report an indication of what was done after the profile swap or, whether or not the attempt to swap the profile was authorized.
